(19) United States
(12) Patent Application Publication
(10) Pub. No.: US 2018/0268347 A1
(43) Pub. Date: Sep. 20, 2018

(54) PROCESSING A SERVICE REQUEST OF A SERVICE CATALOG

(71) Applicant: International Business Machines Corporation, Armonk, NY (US)

(72) Inventors: Fabio Benedetti, Rome (IT); Fabio Cerri, Rome (IT); Giuseppe Ciano, Rome (IT); Marco De Santis, Rome (IT); Alessandro Scotti, Rome (IT)

(21) Appl. No.: 15/461,909

(22) Filed: Mar. 17, 2017

(51) Int. Cl. G06Q 10/06

(52) U.S. Cl. CPC G06Q 10/063118

(57) ABSTRACT

A computer implemented method and system for processing a service request of a service catalog. A service request is received. Context information of a service specification comprised by the service request is determined. Using the context information, a predicted user satisfaction metric is calculated. Based on a predicted user satisfaction indicated by the predicted user satisfaction metric, a response to the service request is determined.

### TECHNICAL FIELD

The present disclosure relates to digital computer systems and, more specifically, to processing a service request of a service catalog.

### BACKGROUND

Service catalogs have been very popular and used for many years in enterprises as a gate to access services provided to employees. Over the years and mainly pushed by the increasing use of cloud computing, service catalogs also referred to as app stores have been evolved to embrace a large set of different types of services and a large audience of users beyond single enterprises. Services provided by service catalogs may include a multitude of details regarding optional as well as obligatory configurations, requirements, behaviors, and capabilities of the respective services. On the other hand, requesters of such services may have very different needs and limited insight into the different types and details of services offered. Furthermore, requesters may want to use the services in diverse contexts and scenarios.

Furthermore, a requester may only with time after having tried a particular service be able to assess whether the service really fits the requester's needs. For example, the dependency of the usability and performance of a requested service on the infrastructure provided by a requester is something which may be experienced by the requester only over time, after the requester already has implemented the service.

As a consequence, it may be very difficult for a user to identify, within a catalog of services, a service specification or even a set of service specifications which may match the user's needs. There is a high probability that a requester may request a service which does not best or even not at all fits the requestor's needs. Hence, there is a need to improve the processing of service requests of service catalogs.

### SUMMARY

Embodiments of the present invention provide a method, and associated computer program product and computer system, for processing a service request of a service catalog. One or more processors of a computer system receive the service request. The one or more processors determine, in real time, context information comprising service context information of a service specification comprised by the service request. The one or more processors calculate, in real time, a predicted user satisfaction metric, using the service context information. Based on a predicted user satisfaction indicated by the predicted user satisfaction metric, the one or more processors determine, in real time, a response to the service request.

### BRIEF DESCRIPTION OF THE DRAWINGS

In the following, embodiments of the invention are explained in greater detail, by way of example only, making reference to the drawings.

FIG. 1 depicts a cloud computing environment according to an embodiment of the present invention.

FIG. 2 depicts abstraction model layers according to an embodiment of the present invention.

FIG. 3 depicts an exemplary computer system/sever configured for performing a method, in accordance with embodiments of the present invention.

FIG. 4 depicts an exemplary computer system configured for requesting a service via a network from the computer system/server of FIG. 3, in accordance with embodiments of the present invention.

FIG. 5 depicts a schematic flow diagram of a first exemplary method for processing a service request of a service catalog, in accordance with embodiments of the present invention.

FIG. 6 depicts a schematic diagram illustrating exemplary sources providing context information, in accordance with embodiments of the present invention.

FIG. 7 depicts a schematic diagram illustrating changes to records for users which are connected to the user requesting the service, in accordance with embodiments of the present invention.

FIG. 8 depicts a schematic flow diagram of a second exemplary method for processing a service request of a service catalog, in accordance with embodiments of the present invention.

FIG. 9 depicts a schematic diagram illustrating exemplary user satisfaction values assigned to the change records of FIG. 7, in accordance with embodiments of the present invention.

### DETAILED DESCRIPTION

According to embodiments, the service request is sent from a computer of a user seeking to implement the service; e.g. on this computer. The request may be sent via a network; e.g., the Internet or an intranet. Such an intranet may for example be an intranet of an enterprise, university, research facility or any other type of organization. The request may be received by a server of a service provider, which provides the service catalogue. Context information of a service specification comprised by the service request may be determined. The context information may comprise information extracted from the service specification as well as information gained from other sources. Other sources may comprise systems of engagement as well as systems of records which may be accessed by the server of the service provider via the aforementioned network or another network. Using the context information, a predicted user satisfaction metric is calculated by the server of the service provider and, based on the predicted user satisfaction indicated by the predicted user satisfaction metric, a response to the service request is determined. The response may be sent to the user's computer (i.e., requester's computer) via the aforementioned network.

A service catalog may refer to an organized and curated collection of information technology related services, in particular computer implemented services. The service catalog may refer to a specific enterprise and comprise all information technology related services that may be performed by, for, or within the respective enterprise. Service catalogs may act as knowledge management tools for employees and consultants of the enterprise enabling the employees and consultants to route their request for and about services and service related topics. By a service catalog, the control of distribution of all services may be centralized. A service catalog may be provided in form of a digital and virtual implementation; e.g., by a software acting as a digital registry enabling a user to seek, find, invoke, and execute services regardless of the user's location. The service catalog may for example be provided by a service catalogue server communicatively connected to a network. The server may further have access to one or more databases comprising for example program instruction for implementing and executing services. The service catalog may further allow tracking and managing metrics which represent the utilization of services and service-related performance indices such as: information about services that are most and least used, services that are successfully provided and services that have problems to be successfully provided, the number of service requests invoked for each service, the number of service deliverables reaching their target service requesters who invoke services most or least, the time required to approve a service request, the time required to deliver service outputs based on an approved request, and service finances.

Furthermore, service catalogs may be used for cloud based services in private and public clouds. Users may be enabled by a cloud service catalog to view which services are provided via cloud computing environment, their features and capabilities as well as their technical requirements.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (Paas): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service IaaS: the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

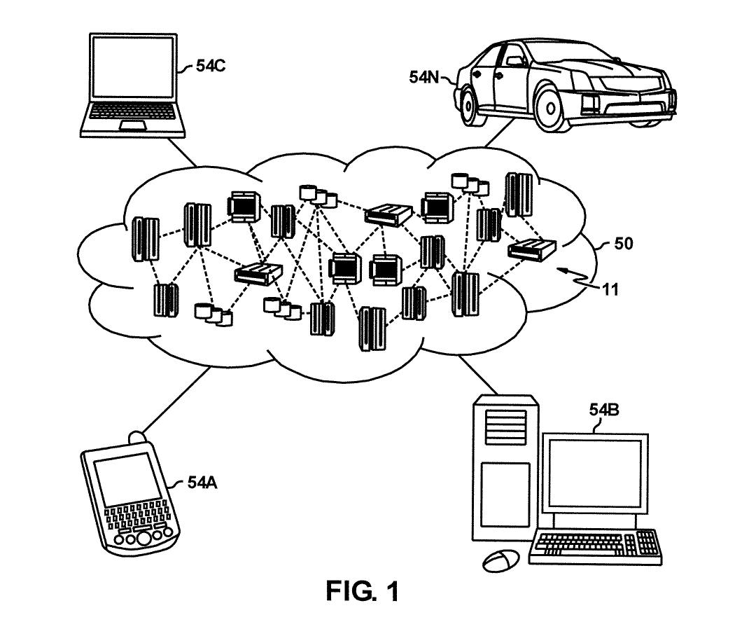

Referring now to FIG. 1 illustrative cloud computing environment 50 is depicted. As shown, cloud computing environment 50 includes one or more cloud computing nodes 11 with which local computing devices used by cloud consumers, such as, for example, personal digital assistant (PDA) or cellular telephone 54A, desktop computer 54B, laptop computer 54C, and/or automobile computer system 54N may communicate. Nodes 11 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 11 and cloud computing environment 50 can communicate with any type of computerized device over any type of network and/or network addressable connection (e.g., using a web browse).

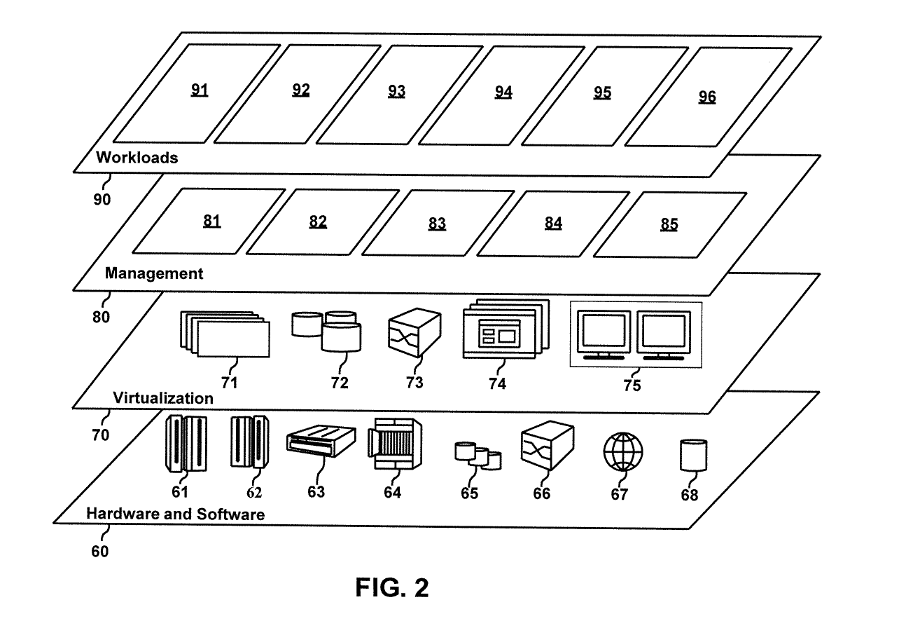

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and service request processing 96.

Unless otherwise stated, the words “user” and “requestor” refer to the same entity.

A service catalog, in particular a service catalog provided via a cloud environment, may be implemented in form of a software distribution catalog such as an app store providing a digital distribution platform for computer software, often for mobile applications. Apps provide a specific set of functions not including the running of a computer system itself. Users may browse through different app categories, view information about each app and acquire apps via the app store. Selected apps may be offered for automatic download, after which the apps are installed on a user terminal device (e.g., a mobile device).

Embodiments may beneficially allow prediction of a user's satisfaction for a service request. Based on the predicted user satisfaction, the user may be provided with suggestions for configuration adjustments or even alternative services which may better suit the user's needs. Thus, it is not necessary for a user to know and understand in detail all the different services available via a service catalog and to identify required and/or advantageous configuration changes for implementing these services. Furthermore, an extensive dialog between the provider and the requester in order to identify suitable adjustments of the configurations to be applied or even an alternative service may be avoided. Considering an individual user, the user may not be able to judge which configurations may be most advantageous for the user due to a lack of experience. For example, a requester may discover the quality of an infrastructure used by the requestor for a service only after having implemented and used the service. Therefore, such interactions between the provider and the requester based on an extensive dialog prior to a service provision may result in extensive costs for the provider and a sense of frustration for the requester, especially in case the requestor does not get what the requestor needs.

Embodiments may be able to utilize the input data provided by the user requesting a service (e.g., configuration, environment, or end user identity), in order to calculate a predicted user satisfaction metric. This predicted user satisfaction metric may provide a prediction for a user satisfaction value estimating the satisfaction that the user will experience when adopting the selected service and suggested configurations. In other words, after selecting a service and its configuration, the system may provide a feedback to the user regarding the service and configuration, and may suggest changes to the configuration or even an alternative service in order to achieve an increased user satisfaction. The user satisfaction may be predicted based on an analysis of, for example, user relationships, interactions between users and the service request and/or a service history. In one embodiment, the response determined may suggest alternative options to the user, terms of services and configurations, in order to maximize the user's satisfaction with the service.

The method may be capable of providing a predicted satisfaction value for a requester of a service based on emotional as well as IT aspects and to suggest alternative options in order to increase the satisfaction value. The satisfaction value may be calculated using a user satisfaction metric providing a measure, in a scale of ordered values, expressing a level of satisfaction a particular user may experience with a chosen service. The satisfaction value may be expressed in form of a number, a sentence or even an image. The satisfaction value may belong to a scale of values immediately recognizable by a requester of the service, when being presented to the requester; e.g., in a response to a service request.

According to embodiments, the predicted satisfaction value may be transmitted to a sender of the service request. Embodiments may have the advantage that the requester of the service may be able to decide whether the predicted satisfaction value is sufficient for the requestor's needs, or whether the requester would like to increase the requestor's predicted satisfaction value (e.g., by selecting alternative configuration options and/or an alternative service).

A satisfaction value may be calculated based upon two main sets of data: data coming from systems of engagement and data coming from systems of records.

The term ‘systems of engagement’ generally pertains to the transition from current enterprise systems designed around discrete pieces of information (e.g., systems of records, to systems which are more decentralized, incorporate technologies which encourage peer interactions and which often leverage cloud technologies to provide capabilities to enable those interactions). A ‘system of records’ refers to an information storage system, commonly implemented on a computer system, that is the authoritative data source for a given data element or piece of information. Systems of records are largely geared toward passively providing information to a user. Systems of engagement may be more close to a user's everyday activities and tend to better capture the mood of the user. In contrast, systems of records may be good at collecting more objective information about users, services and infrastructures, such as tasks, events, status, functional capabilities and dependencies.

According to embodiments, the response is determined such that the predicted user satisfaction indicated by the predicted user satisfaction metric is maximized. Embodiments may have the beneficial effect that the predicted user satisfaction may be maximized. For example, configuration details may not be identified by the service request. Therefore, the response may provide suggestions for configuration options that may be selected based on the predicted user satisfaction for the respective configuration. For example, different configurations may be available and for each configuration, a specific user satisfaction value for the particular user requesting the service may be predicted. The predicted user satisfaction values may be compared and the configuration with the highest user satisfaction value may be selected. Or the user may be provided with a selection of the available configurations which are assigned with the highest satisfaction values. Thus, the user may select based on the response the user receives and/or which configuration details the user would like to implement.

Furthermore, a user satisfaction value may be predicted for the requested service and compared with user satisfaction predictions for alternative services. In case an alternative service is assigned with a higher predicted user satisfaction value, the response may suggest selection of an alternative service. The response may also indicate the higher user satisfaction value assigned to the alternative service.

Embodiments may have the advantage of providing the possibility of predicting individual user satisfaction values for specific users requesting a specific service. In particular, this prediction may be performed dynamically, in real time (i.e., on a computer time scale), for each service request.

According to embodiments, the response comprises a set of service options relating to a service specified in the service specification. Embodiments may have the advantage of providing the user with a set of service options that may result in a maximized user satisfaction. The set of service options may be provided to the user as a fixed set; i.e., the user may either select the whole set to be implemented or refuse the whole set. Alternatively, the set may be provided as a selection of individual service options such that the user may select one or more service options or service option combinations which the user believes suit the user's needs the best. According to embodiments the user may be provided with an updated user satisfaction value, in case the user selects only part of the suggested set of service options or if the user changes suggested service options.

According to embodiments, the response comprises an alternative service specification. Embodiments may have the beneficial effect that the user may be able to select an alternative service, in particular a service the user has not been aware of yet. Thus, the user is not required to have an extensive understanding of the services provided and details and differences of the services. The user may rather automatically be provided with suggestions that may best suit the user's needs based on predicted user satisfaction values for the different service specifications.

According to embodiments, calculating the predicted user satisfaction metric comprises calculating a weighted sum of contributing metrics comprising the context information. Embodiments may have the beneficial effect that different aspects of the context information may be weighted taking into account user-specific circumstances. Thereby, a simple and efficient method may be provided for calculating the predicted user satisfaction metric individually for each user.

According to embodiments, the context information comprises user context information related to a requesting user from whom the service request originates. Embodiments may have the beneficial effect that user context information of the requesting user (i.e., the requester) may efficiently be taken into account when calculating the predicted user satisfaction metric.

According to embodiments, the user context information comprises one or more of the following types of user context information: user state information, user interest information, user preference information, and user configuration information.

Embodiments may have the beneficial effect that a great variety of different types of information may be taken into account in order to estimate a future user satisfaction as accurately as possible. User state information may for example comprise the identity of the user (e.g., the user's name, age, gender). Furthermore, the user state information may comprise information regarding the user's role; i.e., the role for which the user intends to use the service, such as the user's role in an enterprise or in any other kind of community private and/or public. Furthermore, the user state information may comprise information regarding whether the user is married and/or whether the user has children. User interest information may comprise information about the user's interests. This information may for example comprise information about most recent topics followed by the user (e.g., in social communities, in the internet, and/or via newsletters). User preference information may comprise information about the user's preferences, such as review and feedback by the user regarding other topics and/or services from which conclusions may be drawn in view of the service requested. Furthermore, a user preference information may comprise information about configurations and/or services chosen by the user previously. User configuration information may refer to the user environment and the information technology (IT) infrastructure used by he user. For example, the user location may be taken into account. In particular, IT aspects of the location where the services are going to be provided and/or consumed may be considered (e.g., a slow or fast network, specific security requirements such as Virtual Private Network (VPN) or no available internet access etc.). Furthermore, the proximity of infrastructure elements that may improve the effectiveness of a requested service may be taken into account (e.g., a storage service for a local provider, possible support from local developers, etc.). Furthermore, assets available for the user as well as assets required by the requested service may be taken into account. Assets may be physical as well as digital assets, such as e.g. hardware, firmware, and software assets. The available infrastructure may be decomposed into assets, and events of a knowledge base (e.g., an information technology infrastructure library (ITIL) or a configuration management database (CMDB)) may be used to evaluate particular aspects of the service, such as e.g. changes, incidents, and/or problems related to the involved assets, which may help to establish a likelihood for problems occurring, when using the available infrastructure for implementing the service. Furthermore, user defined configurations may be compared with other configurations for the same service. Configuration similarities may be evaluated and matches may be found with configuration-related positive and/or negative events, in order to understand the possible level of satisfaction for the configuration chosen by the user.

According to embodiments time may be taken into account when assigning weighting factors to the contributing matrices. More recent events may be more relevant for predicting a user satisfaction than events and/or information that date long in the past.

According to embodiments, the user context information comprises relationship information about a relationship of the requesting user to other users and additional user context information related to one or more of the other users. Embodiments may have the beneficial effect that not only user context information of a single user may be taken into account but user context information of a plurality of users may be used in order to improve the prediction of the user satisfaction value for a particular user. Relationships to other users may be taken into account depending on relevance of the relationships (e.g., on the grade of similarity between the requesting user and the other user). Relevant users taken into account may for example be users of the same department, having the same role or being linked to the user via a social network (e.g., LinkedIn®, Twitter®, Facebook®, etc.). For example, the proximity of users who submit reviews and/or feedback of the service may be taken into account. For example, a local colleague who requested the same service and is particularly happy about the chosen configuration may be used to predict an increased level of satisfaction in case the requesting user implements the requested service.

A requester may choose a specific service in a catalog of services and provide as an input a specific service configuration desired.

According to embodiments, the context information comprises service context information related to the service specified in the service request. Embodiments may have the beneficial effect that also service-specific context information may be taken into account.

According to embodiments, the service context information comprises one or more of the following types of service context information: service infrastructure requirement information, service history information, and service assessment information. Service infrastructure requirement information may refer to the infrastructure required by the service in order to work at all and/or in order to provide its full potential. A service history information may refer to the service history (e.g., the effectiveness of the service by analyzing historical data). This historical data may comprise incidents and problems related to the service, such as how many times issues occurred with the infrastructure and/or the service. Furthermore, the historical data may comprise information about changes implemented by other users using the same service such as how many requests have been made to change the configuration to adapt a user system. Furthermore, configurations submitted by other users may be taken into account as well as successful and/or failed service implementations occurred. Service assessment information may for example comprise reviews and/or feedback regarding the requested service from different systems of engagement provided by other users.

A user's expected level of satisfaction may be expressed as a number SV (satisfaction value) which may be calculated as a weighted sum of key aspects related to the service request; i.e., as mentioned above emotional and IT aspects as well as information. This number may be translated into an image, sentence, emoticon or whatever may better represent the scale of values for a user. The weighted sum for calculating a user satisfaction value may have the following form:

$$SV = {\sum }_{x = 1}^{N} {WU}_{x} \cdot {UserD}_{x} + {\sum }_{y = 1}^{M} {WS}_{y} \cdot {ServiceD}_{y}$$

With the contributing user metric UserD comprising user context information UserDx of user context information type x. UserDx may describe a user dependent contribution to the satisfaction value (e.g., a connection with a local colleague already using the requested service). The weighting factor WUx may be assigned to the specific user context information UserDx to the satisfaction value SV. For example the weighting factor may be higher if assigned to a user contribution related to a local colleague who has the same role as the user in the enterprise, while the weighting factor may be lower if the colleague may have a quite different role or may be located a geographical distance away. A geographical distance may in particular be relevant, when resulting in a different language being used and/or a different character encoding, etc. N denotes the number of individual types of user context information contributing to SV.

The contributing metric ServiceD may comprise service context information ServiceDy of service context information type y. A service-dependent contribution of service context information ServiceDy may for example be based on a great number of incidents associated to the requested service registered in a knowledge base of the enterprise. The weighting factor WSy assigned to the specific service contribution ServiceDy may for example indicate the importance of the incident registered in the knowledge base. For example low priority defects may be assigned with a lower weighting factor than system down events. Also, security issues may be assigned with a larger weighting factor. M denotes the number of individual types of service context information contributing to SV.

According to embodiments, determining the service context information comprises analyzing the service request. The current configuration state related to the service request is identified and a list of basic installations and changes of configuration items required for satisfying the service request starting from the current configuration state using the service infrastructure requirement information is determined. The list defines a target configuration state. A set of change history records related to other users and comprised by the service history information is accessed. Each change history record comprises a chronological order of configuration states and identifies installations and changes of configuration items resulting in the configuration states. A subset of the set change history records is identified. Each change history record of the subset comprises a reference configuration state which comprises the target configuration state. For each change history record of the subset, a starting configuration state is defined. The starting configuration state is a configuration state which chronologically precedes the reference configuration state of the respective change history record and which is most similar to the current configuration state assigned to the service request. For each change history record of the subset, a reference set of installations and changes of configuration items is identified. The reference set comprises the installations and changes of configuration items implemented according to the respective change history record in order to arrive at the reference configuration state starting from the starting configuration state of the respective change history record. The determined response comprises one or more installations and changes of configuration items comprised by a reference set selected from the reference sets of the change history records of the subset.

Embodiments may beneficially recommend installations and changes of configuration items based on service history information, more precisely based on configurations already implemented by other users.

The term configuration item may refer to a fundamental structural unit of a configuration management system. A configuration item (CI) may for example include requirements, documents, software, models and plans. A configuration management system may oversee the life of the configuration items through a combination of processes and tools by implementing and enabling fundamental elements of identification, change management, status accounting, and audits. CI types may, for example, comprise hardware, software, communications/networks, location, and documentation. A configuration item may refer to anything designed for the application of the elements of configuration management and treated as a single entity in the configuration management system. The respective identity may be uniquely identified to be distinguished from all other configuration items. Furthermore, from the perspective of a configuration change, the CI may identify what the respective change comprises. Altering a specific baseline version of a configuration item may create a new version on the same configuration being itself a baseline.

Embodiments may have the beneficial effect that a desired target configuration state may efficiently be identified based on an analysis of the service request. Furthermore, a current configuration state related to the service request (i.e., the current configuration state of the user system) may be taken into account. The desired target configuration state may be used to identify such change history records which comprise the desired target configuration state; i.e., those changes to records which may provide information about possible installations and changes of configuration items resulting in the desired target configuration state. For those change history records, which comprise the target configuration state, the history may be analyzed backwards in time in order to find a configuration state which is most similar to the current configuration state. This current configuration state provides a starting point for the user requesting the service. The installations and changes of configuration items which have taken place according to the new change history records between the most similar configuration which provides a starting configuration state for the analysis and the desired target configuration states which may be comprised by a reference configuration state.

The installation and changes of configuration items implemented to achieve the reference configuration state may be summarized in reference sets. The determined response to the service request may comprise one or more installations and changes of configuration items as recorded by one of the change history records. The reference sets may provide information on the best ways to satisfy the user request.

According to embodiments, the analyzing of the service request comprises identifying service sub-requests comprised by the service request, and the determined list of basic installations and changes of configuration items comprises basic installations and changes of configuration items required to be installed or changed in order to satisfy the service sub-requests. Embodiments may have the beneficial effect that a complex request may be effectively analyzed and a suitable response may be determined. A request may comprise a plurality of sub-requests which may be more or less dependent on each other. Therefore, it may be advantageous to analyze the structure of the sub-requests and to identify optimized service options for the services requested by the sub-requests. Service options for a service requested by a sub-request may be optimized such that the predicted user satisfaction value may be maximized.

According to embodiments installations and changes of configuration items implemented after the reference configuration state was established may provide information on the likely user satisfaction value after the requested services are implemented, which for example, in case multiple and/or extensive modifications have been applied to the reference state, may indicate that the user in case of the respective change history record was not satisfied with the result of the service implementation.

According to embodiments, the subset of the set of change history records is extended by adding change history records with a reference configuration state which comprises a selected part of the target configuration state. Embodiments may have the beneficial effect that not only changes to records are taken into account which result in a reference configuration state comprising the full target configuration state but also to such change history records which achieve only part of the target configuration state, which may have the advantage that also implementations may be taken into account which deviate from the user request, but which may result in a larger user satisfaction value. Thereby, alternative service options and/or even alternative service specifications may be identified and suggested to the requester. The part of the target configuration state which at least has to be achieved by a change history record in order to be taken into account for the further analysis may for example be defined by a threshold which has to be exceeded. The threshold may be provided by a number of installations and changes of configuration items or using a categorization of the configuration items. For example, the categorization may categorize the configuration items according to the priority of the configuration items. Changes to be taken into account may for example have to comprise a reference configuration state which comprises all parts of the target configuration states which are categorized as being high priority while those configuration items which are assigned with a low priority may be optional.

According to embodiments, the selected reference set is selected using satisfaction values assigned to the configuration states comprised by change history records of the subset. Embodiments may have the beneficial effect that the selection of the best way to satisfy a user request (i.e., the selection of installations and changes of configuration items to be taken into account or the response) may be selected based on a maximized satisfaction value.

According to embodiments, the computer implemented method further comprises identifying a first change history record of the subset with the highest satisfaction value assigned to the reference configuration state of the respective change history record. The selected reference set is the reference set of the first change history record of the subset. Embodiments may have the beneficial effect of selecting a change history record (i.e., the first change history record) for which the highest user satisfaction value has been recorded related to the reference configuration state (i.e., target configuration state). By selecting installations and changes of configuration items, which have in the past resulted in the desired target configuration state, in such a way that a maximum user satisfaction value has been reached, may also be the best choice for a current request in order to satisfy the user's request in an optimal way.

According to embodiments the installations and changes of configuration items comprised by the reference set may be compared to the installations and changes taken into account for defining the target configuration state. Differences may be identified and the installation and changes of configuration items identified in order to achieve the target configuration state may be replaced or amended using the reference set. Furthermore, differences between the current configuration state and the starting configuration state of the changes to re-record the selected reference set may be identified and installations and changes of configuration items suggested to the user such that his current configuration state may be transformed into the starting configuration state in order to reach the same maximum user satisfaction value which has been recorded for the respective changes to record.

According to embodiments, the computer implemented method further comprises identifying an increase of the satisfaction values assigned a reference set of installations and changes of configuration items of a second change history record of the subset. The selected reference set is the reference set of the second change history record of the subset. Embodiments may have the beneficial effect that an increasing user satisfaction value in the past may indicate installations and changes of configuration items which may also result in an increased user satisfaction value for the current user request. These installations and changes of configuration items increasing the user satisfaction value may also be suggested as the response to the current requester.

According to embodiments, the computer implemented method further comprises identifying installations and changes of configuration items of the reference set of the second change history record implemented previous to the increase of the satisfaction value. It is checked whether the identified installations and changes of configuration items are comprised by reference sets of other change history records of the subset which do not comprise the same increase of satisfaction values. In case the identified installations and changes of configuration items are not comprised by reference sets of other change history records of the subset which do not comprise the same increase of satisfaction values, the identified installations and changes of configuration items is added to the response.

Embodiments may have the beneficial effect that by comparing installations and changes of configuration items which have been implemented prior to an increase of a user satisfaction value with installations and changes of configuration items having been implemented without resulting in the same or a comparable increase of the user satisfaction value may provide an effective criterion to decide whether the identified installations and changes of configuration items have indeed been the reason for the increasing user satisfaction value or whether the chronological order was only a matter of chance. In case installations and changes of configuration items can be identified for which an increasing user satisfaction value is recorded and would not have been recorded by any of the other change history records without resulting in an identical or at least a similar increase of the user satisfaction value may indicate that with a high probability the respective installations and changes of configuration items are indeed responsible for the observed increase of the user satisfaction.

According to embodiments, the computer implemented method further comprises transmitting the response to the service request to a sender of the service request.

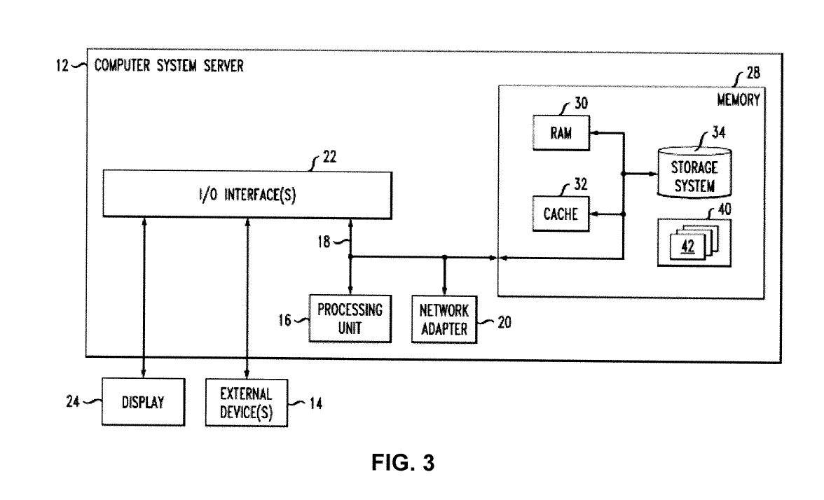

FIG. 3 depicts an exemplary computer system/server 12 configured for performing a method, in accordance with embodiments of the present invention. The computer system/server 12 may be used to provide a service catalog and implement a method for processing a service request of a service catalog. Computer system/server 12 is only one example of a suitable computer system/server and is not intended to suggest any limitation as to the scope of use or functionality of embodiments of the invention described herein. Regardless, computer system/server 12 is capable of being implemented and/or performing any of the functionality set forth hereinabove.

Computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may for example be practiced in distributed cloud computing environments where tasks are performed by remote processing devices that are linked through a communications network. In a distributed cloud computing environment, program modules may be located in both local and remote computer system storage media including memory storage devices.

In FIG. 3, computer system/server 12 is shown in the form of a general-purpose computing device. The components of computer system/server 12 may include, but are not limited to, one or more processors or processing units 16, a system memory 28, and a bus 18 that couples various system components including coupling system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/sever 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. Storage system 34 may for example comprise one or more database providing information, e.g. context information. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein. Program modules 42 may in particular be configured for processing a service request of a service catalog provided by computer system/server 12.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

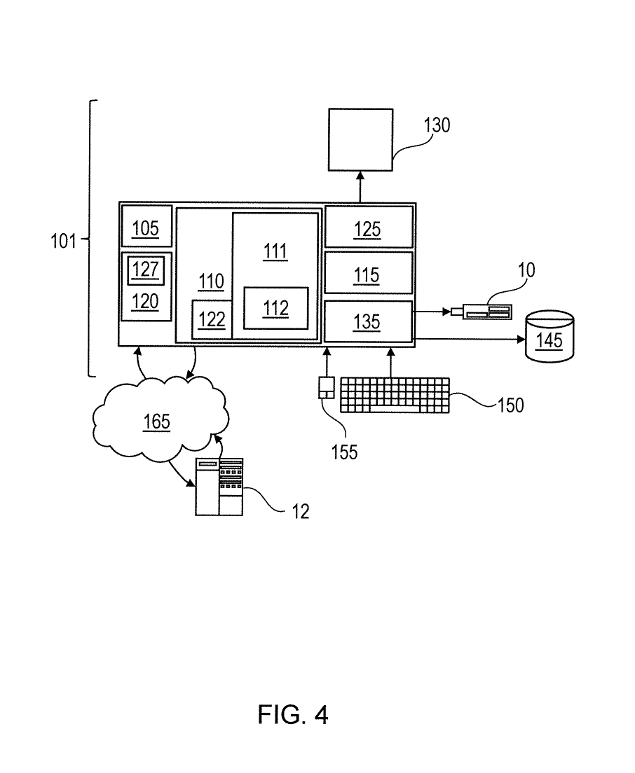

FIG. 4 depicts an exemplary computer system 101 configured for requesting a service via network 165 from the computer system/server 12 of FIG. 3, in accordance with embodiments of the present invention. It will be appreciated that the computer system 101 described herein may be any type of computerized system comprising a plurality of plurality of processor chips, a plurality of memory buffer chips and a memory. The computer system 101 may for example be implemented in form of a general-purpose digital computer, such as a personal computer, a workstation, or a minicomputer.

In exemplary embodiments, in terms of hardware architecture, as shown in FIG. 3, the computer 101 includes a processor 105, memory (main memory) 110 coupled to a memory controller 115, and one or more input and/or output (I/O) devices (or peripherals) 10, 145 that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein the I/O devices 10, 145 may generally include any generalized cryptographic card or smart card known in the art.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory modules (e.g., random access memory (RAM, such as DRAM, SRAM, SDRAM, etc.)) and nonvolatile memory modules (e.g., ROM, erasable programmable read only memory (EPROM), electronically erasable programmable read only memory (EEPROM), or programmable read only memory (PROM)). Note that the memory 110 can have a distributed architecture, where additional modules are situated remote from one another, but can be accessed by the processor 105.

The software in memory 110 may include one or more separate programs, each of which comprises an ordered listing of executable instructions for implementing logical functions, notably functions involved in embodiments of this invention. For example, the executable instructions may be configured to generate and send services request, receive responses and implement services provided by a server 12 via network 165. The software in memory 110 may further include a suitable operating system (OS) 111. The OS 111 essentially controls the execution of other computer programs, such as possibly software 112.

If the computer 101 is a PC, workstation, intelligent device or the like, the software in the memory 110 may further include a basic input output system (BIOS) 122. The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured for executing software 112 stored within the memory 110, to communicate data to and from the memory 110, and to generally control operations of the computer 101 pursuant to the software. The methods described herein and the OS 111, in whole or in part, but typically the latter, are read by the processor 105, possibly buffered within the processor 105, and then executed.

Software 112 may further be provided stored on any computer readable medium, such as storage 120, for use by or in connection with any computer related system or method. The storage 120 may comprise a disk storage such as HDD storage. Data and/or program code 127 for implementing the methods of the present invention is stored on storage 120.

In exemplary embodiments, a conventional keyboard 150 and mouse 155 can be coupled to the input/output controller 135. Other output devices such as the I/O devices 145 may include input devices, for example but not limited to a printer, a scanner, microphone, and the like. Finally, the I/O devices 10, 145 may further include devices that communicate both inputs and outputs, for instance but not limited to, a network interface card (NIC) or modulator/demodulator (for accessing other tiles, devices, systems, or a network), a radio frequency (RF) or other transceiver, a telephonic interface, a bridge, a router, and the like. The I/O devices 10, 145 can be any generalized cryptographic card or smart card known in the art. The system 100 can further include a display controller 125 coupled to a display 130. In exemplary embodiments, the system 100 can further include a network interface for coupling to a network 165. The network 165 can be an IP-based network for communication between the computer 101 and any external server, like server 12, other client and the like via a broadband connection. The network 165 transmits and receives data between the computer 101 and server 12 providing a service catalog. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

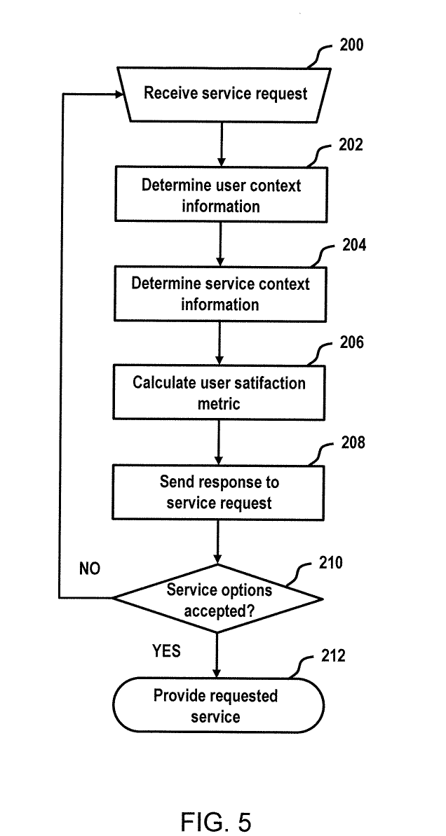

FIG. 5 depicts a schematic flow diagram of a first exemplary method for processing a service request of a service catalog, in accordance with embodiments of the present invention. In step 200, a service request is received from a user requesting a service of a service catalog. In step 202, the system collects user context information related to the requesting user. The user context information may for example comprise relationships of the user with other persons, such as persons the user knows, persons having the same or a similar role, a person having the same or a similar job, persons working in the same enterprise or in an enterprise in the same field, etc. Furthermore, the user context information may comprise the rest of the users as well as topics most recently followed by the user. Additionally, the user context information may comprise topics and persons having relationships with a specific service or similar services and context information related to these persons. In step 204, the system may collect service context information related to the requested service. The service context information may comprise information about the infrastructure required by the service (e.g., composing the service in assets). Furthermore, information regarding the defectiveness of the service may be gained by analyzing historical data of the composing assets. The historical data may comprise data regarding incidents and problems which have occurred with the servers and/or the required infrastructure. This information may comprise details regarding the type of incident/problem as well as the time, frequency and/or total number of occurrences of such incidents and/or problems. Furthermore, the historical data may comprise change information, for example regarding the question how may requests have been made to change the configuration desired by the received user request to adapt the resulting configuration state to the user's needs in the past. Furthermore, the service context information may comprise review and feedback of other users of the same service from different systems of engagement. The service context information may also comprise information about successful and failed implementations of the service as well as configurations implemented by other users.

In step 206, a user satisfaction metric is calculated using the context information gained in steps 202 and 204. The system calculates the user satisfaction metric of the service configuration requested by the user and in case for better options. This calculation may be based on an analysis of data process that calls a set of functions which may be tuned and adapted to the specific context of use in order to make the entire calculation more efficient and effective. Such tuning and adaption of the calculation may be automated by adjusting the algorithm relying on historical data of users' decisions. In step 208, the user may be provided with a response to the user's service request. The response may comprise a feedback which indicates service options and/or an alternative service specification which may result in a maximized user satisfaction value. In order to provide this feedback in step 208, user satisfaction values may be predicted for the requested service. Furthermore, user satisfaction values may be predicted for different service options and/or alternative service specifications. For the feedback, those service options and/or alternative service specification may be chosen which are assigned with a larger user satisfaction value than the requested service and/or with a maximum user satisfaction value. In step 210, the user may decide based on the received feedback, whether the service requested in step 200 is actually the service which best suits the user's needs and/or whether the user would like to accept the suggested service options. In case the requested service is still considered to be the service best suiting the user's needs, the method may continue in step 212 providing the requested service. The method may also continue in step 212 in case service options suggested by the feedback in step 208 are accepted without requiring a new service request. In case the user decides in step 210 that there are better alternatives suggested by the feedback of step 208, the method may continue with step 200 by requesting an alternative service, which is an alternative embodiment in which the better alternatives suggest alternative options to the user, terms of services and configurations, in order to maximize the user's satisfaction with the service.

In the preceding alternative embodiment, the user experiences a time delay in receiving the requested service, due in part to looping from step 210 back to step 200 to benefit from the better alternatives stemming from the response received in step 208, as compared with receiving the requested service directly in response to the service request in step 208. The time delay may contribute to a degree of user dissatisfaction. Therefore, to eliminate, or significantly reduce, the preceding user dissatisfaction, the steps in FIG. 5 could, in one embodiment, be implemented in real time (i.e., on a time scale of computer time) which would necessitate use of a computer to perform the method of FIG. 5 and would provide significantly more satisfaction to the user than if the method of FIG. 5 were implemented without a computer.

Moreover, step 210 itself requires a decision by the user which may be a source of time delay, and steps 202-210 could cause significant time delay if implemented manually which could contribute to another degree of user dissatisfaction.

Therefore, since the method of FIG. 5 aims to increase the user's net satisfaction in receiving the response to the service request, which is impacted by both the received the requested service and the elapsed time from making the service request and receiving the requested service, performing all embodiments of FIG. 5 in real time (i.e., on a computer time scale) by a computer would provide significantly more net satisfaction to the user than if the method of FIG. 5 were performed manually without a computer.

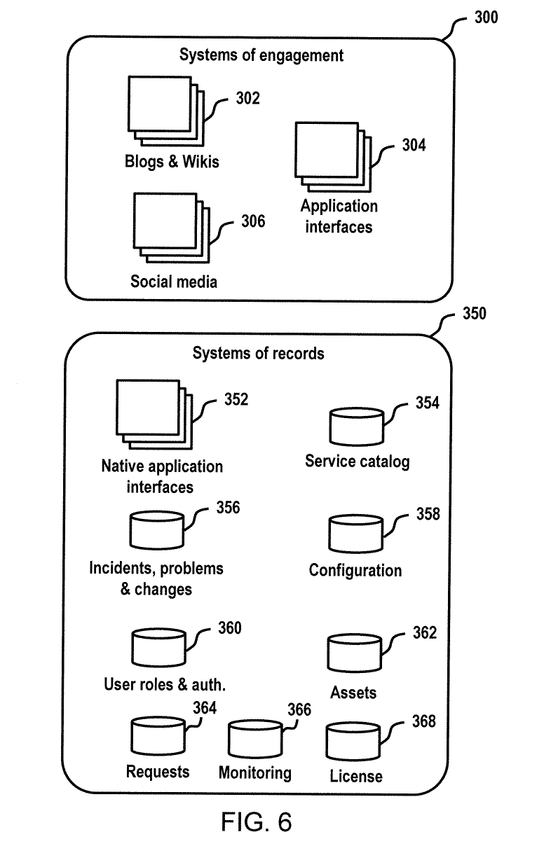

FIG. 6 depicts a schematic diagram illustrating exemplary sources providing context information, in accordance with embodiments of the present invention. A source may for example be provided by systems of engagement 300, such as blogs and Wikis 302, application interfaces 304, and social media 306 (e.g., LinkedIn, Twitter, Facebook etc.). Blogs and Wikis 302 may provide reviews and feedback by the user requesting a service as well as other users which have experience with the requested service. Application interfaces 304 may provide information about the user's interests and preferences as well as issues which have occurred with the services earlier. Social media 306 may provide information about relationships between the user and other users. Furthermore, the social media may 306 provide reviews and feedbacks regarding the requested service as well as information about the user's interests and preferences.

Another source for the user and service context information may he provided by systems of records 350. The systems of records 350 may comprise native application interfaces 352, the service catalog 354, records 356 about incidents, problems and changes related to the requested service, records 358 about configurations of the service, information 360 about user roles and authorities, assets 362 relevant for the service, requests 364 relating to the requested service, monitoring data 366 recorded regarding the service in the past, as well as licenses 368 which are related to the requested service.

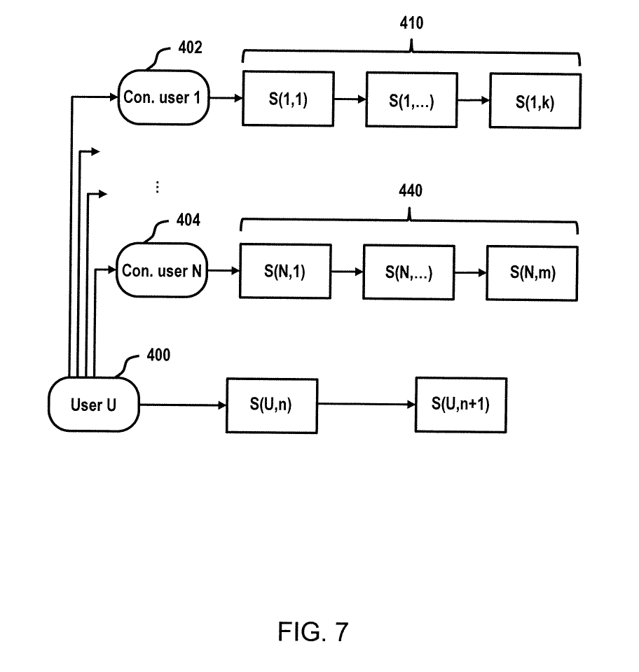

FIG. 7 depicts a schematic block diagram illustrating changes to records for users which are connected to the user requesting the service. User 400 may be connected with a plurality of other users 402, 404. These other users 402, 404 may for example be colleagues, co-workers and/or people at the same location etc. There may be a number of N connections to N other users 402, 404. Each connection may be related to a history of change management; i.e. a history of states of assets and configuration items associated to the N connections. This history of change management may he provided in form of a change history record 410, 440 for each of the other users 402, 404. The change history records may start with an initial state S(I,1) with I being element of (1, . . . N), to a current state S(I,J) with J being a number assigned to the current state, e.g. depending on the number of changes performed so far, and which may be different or equal for different users 402, 404. For example, it may be assumed that each connection is associated to a single physical asset (i.e., a computer and to a single location). However, there may still be multiple software assets, licenses and services etc. For every state S(I,J), the respective change history record provides information about when this state S(I,J) occurred; i.e., when the system completed the change from state S(I,J−1) to S(I,J). Furthermore, the respective change history record provides information about characteristics of the system in state S(I,J). The change history records may be provided by any kind of asset/configuration management software. The state history may be considered as a timeline starting with some point in the past and running up to the present state. Different connections may start at different points of course and may have generally different histories. However, considering these timelines not from a time perspective, but from a system state perspective, it may be possible to leverage the knowledge of past changes to predict the results of future changes. Suppose that connections A, B and. C are currently in states S(A, J), S(B,K), and S(C,L) respectively, and also that such states are identical; i.e.,

S(A,J)=S(B,K)=S(C,L).

When user A applies a change CHG1 to his system, the state moves to state S(A,J+1). When user B applies a change CHG9 to his system, the same may move to state S(B,K+1). Since the states have initially been identical, the changes CHG1 and CHG9 that A and B have applied may imply timelines for user C. For the changes already applied we know that

S(C,L)+CHG1=S(C,L+1)=S(A,J+1)

and

S(C,L)+CHG9=S(C,L+1)=S(B,K+1).

Since all users started from identical initial states, the next state may be predicted based on the changes applied. When A and B apply further changes the timelines of A and B may extend to S(A,J+2), S(A,J+3), etc. and S(B,K+2), S(B,K+3), etc., which may allow to predict or estimate even further into the future of C under the assumption that C implements the same changes. Every future timeline runs only on a precise sequence of changes, but as it may become apparent from the above, it is impossible to leverage multiple timelines that intersect and use the multiple timelines to build several alternative futures for the state assigned to the intersection. In this example, identical states are assumed. The same may still be true for states which are not identical but are sufficiently similar. The more the states differ from each other the less reliable the predictions are.

Systems of record databases may comprise tickets (e.g., of an issue tracking system). A ticket element within an issue tracking system is a running report on a particular issue. The system of records may further comprise change history records. Such a record may comprise an initial state, which may be provided by a first set of configuration items, a change request; e.g., a ticket identifying installations and changes of configuration items, as well as a final state, provided e.g. by a second set of configuration items. The system of records may further identify configuration items which may comprise hardware assets, software assets including services, etc. Furthermore, the configuration items may comprise information about users as well as performance and usage metrics, comprising, for example, key performance indices (KPI). A user may for example submit a request R. For example, the user may request to install a LAMP stack. LAMP refers to a generic software stack model comprising a Linux operating system, an Apache HTTP Server, a MySQL relational database management system (RDBMS), and the PHP programming language. The LAMP components may be interchangeable and not limited to the aforementioned components.

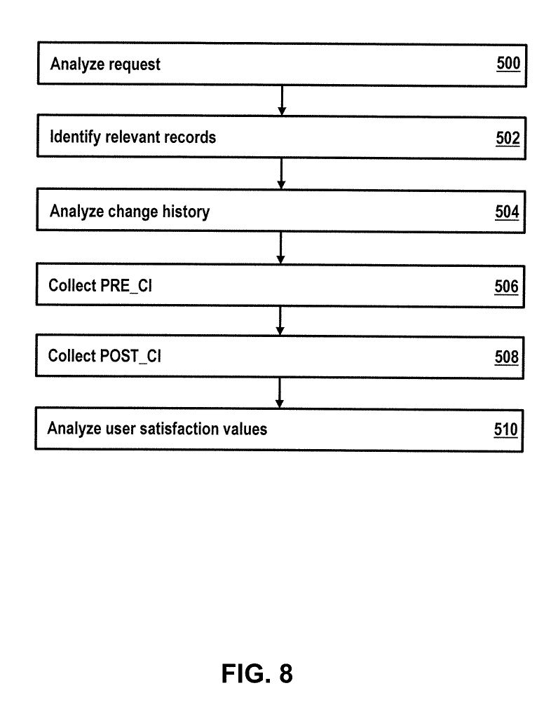

FIG. 8 depicts a schematic flow diagram of a second exemplary method for processing a service request of a service catalog, in accordance with embodiments of the present invention. In step 500, the request is analyzed and expanded to identify possible sub-requests. As a result, a list of configuration items to be installed change this output. In step 502, in a change database provided by the system of records all records are identified, in which the final state includes the configuration items identified in step 500. The result is a set of records C1, . . . , CN, which may refer to changes in the past and/or that occurred at a different location resulting in a final state that reflects the goal of the request R. Considering a particular computer or machine there may likely be many change records that match the above criterion. For example, an installation of LAMP may result in a final state comprising the configuration items identified in step 500. An installation of e.g. Lotus Notes afterwards may result in a new state which still matches the criterion, since the configuration items identified in step 500 are still comprised. In order to remove such duplicates, in one embodiment only the oldest record may be considered for the following analysis. The logic behind this is the following: if there are multiple changes applied, the oldest change record may be selected because if the oldest change record has been maintained and not reverted, it may be inferred that a stable and verified change has been provided. Thereby, more reliable results may be provided.

In step 504, for any change record the change history may be analyzed going backwards in time until a state is identified that is closest to the current state of the requesting user. This identified state may be referred to as START_CI. In step 506 all changes between START_CI and CI may be collected. This change history may be referred to as the set PRE_CI. In step 508, all changes registered after CI may be collected and referred to as the set POST_CI. In step 510, the users associated with the assets impacted by the above identified configuration items are taken into account. Based on these users and their satisfaction values recorded for the past, predictions for future user satisfaction values, when implementing the respective configuration items, may be predicted. Thus, the set PRE_CI may provide information on the best way to satisfy a user request R, while the set POST_CI may provide information on what the likely user satisfaction may be after the request has been performed.

For calculating the predicted user satisfaction metric, the service context-related information may be taken into account as follows: for example, all tickets open against the Apache Server of the previously mentioned LAMP configuration may be identified and counted. According to embodiments the result may be scaled and normalized. The result may be used as the parameter ServiceDy. In order to determine a weighting factor WSy for this parameter ServiceDy, the service statistics may be accessed and the number of times the respective service has actually been used may be identified. If the Apache Server was heavily used (e.g., thousands of accesses), the weighting factor WSy may be larger; otherwise if the Apache Server was rarely used (e.g., few access per day), the weighting factor may be smaller. Weighting factors WSy may further include other factors (e.g., access concurrency).

User context information may be taken into account by going over the list of tickets that are related to one of the configuration item changes identified by the request (e.g., one of the LAMP components). Furthermore, a sentiment analysis on chats or discussion groups (e.g., an enterprise internal discussion group, blog, Wiki, etc.), may be used to get feedback on the respective components, which may result in a parameter UserDx. In order to determine a weighting factor WUx for the parameter UserDx, it may be estimated how similar the user assigned with parameter UserDx is or is not to user U (e.g., having the same job, having the same role, etc.). For example, the following factors may be taken into account: job role, location (i.e., proximity), management chain.

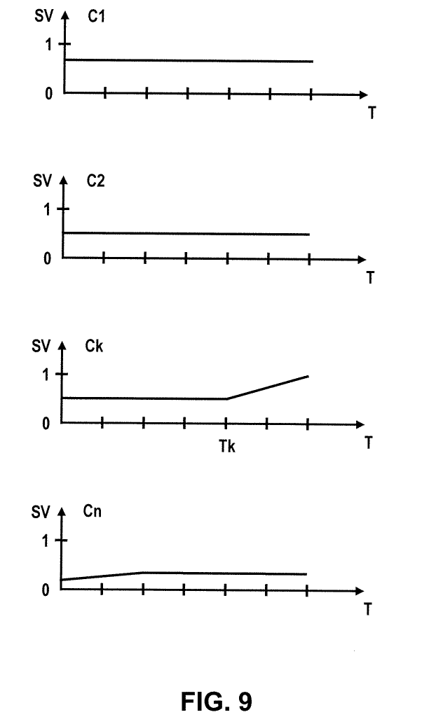

FIG. 9 depicts a schematic diagram illustrating user satisfaction values. The previously introduced satisfaction formula may be used to assign satisfaction values assigned to the change records of FIG. 7, in accordance with embodiments of the present invention. The satisfaction values may be normalized such that the satisfaction values are between 0 and 1, 0 indicating not satisfied at all and 1 indicating fully satisfied. Respective user satisfaction values may be calculated for each change referred to above. Each of these change records represent the same final state and for each of the change records, a START_CI state has been identified that is as close as possible to the current configuration state of user U. Therefore, it may be expected that all the PRE_CI states may be similar to each other. Thus, when the user satisfaction values assigned to those change reports differ, the list of changes that leads from START_CI to the final state may be analyzed in more detail in order to identify what causes the difference regarding the user satisfaction values. Using sentiment analysis and other metrics examined above, a satisfaction metric may be assigned also to the intermediate states leading from the START_CI state to the final state.

In case that for one system CK, the satisfaction value increases significantly at some time Tk, the configuration states prior to time Tk may be analyzed in more detail. The changes that led to those states, in particular the respective configuration items, may be collected. This set of changes may be referred to as CHJ. This set of changes may be compared with the changes comprised by other systems without the respective increase of the user satisfaction value. It may be checked whether the respective systems also comprise the same changes. When several systems have all one or more of the changes comprised by the set CHJ, but do not display the same increase or a comparable increase, the changes CHJ may be neglected due to the fact that even if the changes CHJ occur in a system with increasing user satisfaction value, the changes CHU may not he responsible for the observed increase. Repeating this process for all systems may result in a set of changes that quite likely is responsible for the increase of the user satisfaction value. For example, suppose a LAMP system is requested to be installed, but the enterprise provided workstation may only be provided with 1 GB of RAM. The LAMP services may therefore struggle to work with not enough RAM provided such that the system is under stress and may become slow and less responsive. Suppose for some arbitrary reason, the user associated with one timeline upgrades the RAM to 4 GB such that the service works well on the user's workstation and the user's satisfaction value starts to increase. The positive event, i.e. user satisfaction value starting to rise, may be identified and the change list of changes applied prior to this increase may be back traced to the moment the RAM was upgraded and a respective ‘RAM upgrade’ even may be encountered. This event may be related to the increasing user satisfaction value, because systems having low user satisfaction values do not have such RAM, and systems having better user satisfaction scores may have RAM larger than 1 GB; i.e., the initial amount of RAM. The preliminary sentiment analysis may not identify significant changes, but may greatly restrict the number of changes to search for, so improving the performance of the system while reducing the system's requirements at the same time.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device,

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A computer program product of the present invention comprises one or more computer readable hardware storage devices having computer readable program code stored therein, said program code executable by one or more processors of a computer system to implement the methods of the present invention.

A computer system of the present invention comprises one or more processors, one or more memories, and one or more computer readable hardware storage devices, said one or more hardware storage device containing program code executable by the one or more processors via the one or more memories to implement the methods of the present invention.

In one embodiment, the computer or computer system may be or include a special-purpose computer or machine that comprises specialized, non-generic hardware and circuitry (i.e., specialized discrete non-generic analog, digital, and logic based circuitry) for (independently or in combination) particularized for executing only methods of the present invention. The specialized discrete non-generic analog, digital, and logic based circuitry may include proprietary specially designed components (e.g., a specialized integrated circuit, such as for example an Application Specific Integrated Circuit (ASIC), designed for only implementing methods of the present invention).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein. What is claimed is:

1. A computer implemented method for processing a service request of a service catalog, said computer implemented method comprising the steps of:
receiving, by one or more processors of a computer system, the service request;
determining, in real time by the one or more processors, context information comprising service context information of a service specification comprised by the service request;
calculating, in real time by the one or more processors, a predicted user satisfaction metric, using the service context information; and
based on a predicted user satisfaction indicated by the predicted user satisfaction metric, determining, in real time by the one or more processors, a response to the service request.

2. The computer implemented method of claim 1, said response being determined such that the predicted user satisfaction indicated by the predicted user satisfaction metric is maximized, wherein user dissatisfaction due to time delay is significantly reduced due to use of the one or more processors recited in claim 1 in performing steps in claim 1 in real time.

3. The computer implemented method of claim 2, said response comprising a set of service options relating to a service specified in the service specification.

4. The computer implemented method of claim 2, said response comprising an alternative service specification.

5. The computer implemented method of claim 2, wherein said calculating the predicted user satisfaction metric comprises calculating a weighted sum of contributing metrics comprising the context information.

6. The computer implemented method of claim 2, said context information further comprising user context information related to a requesting user from whom the service request originates.

7. The computer implemented method of claim 6, said user context information comprising one or more of the following: user state information, user interest information, user preference information, and user configuration information.

8. The computer implemented method of claim 7, said user context information comprising relationship information about a relationship of the requesting user to other users and additional user context information related to one or more of the other users.

9. The computer implemented method of claim 2, wherein the service context information is related to a service specified in the service specification.

10. The computer implemented method of claim 9, said service context information comprising one or more of the following: service infrastructure requirement information, service history information, and service assessment information.

11. The computer implemented method of claim 10, said determining the service context information comprising:
analyzing the service request;
identifying a current configuration state related to the service request;
determining a list of basic installations and changes of configuration items required for satisfying the service request starting from the current configuration state using the service infrastructure requirement information, the list defining a target configuration state;
accessing a set of change history records related to other users comprised by the service history information, each change history record comprises a chronological order of configuration states and identifies installations and changes of configuration items resulting in the configuration states;
identifying a subset of the set change history records, each change history record of the subset comprising a reference configuration state which comprises the target configuration state;
identifying for each change history record of the subset a starting configuration state being a configuration state which chronologically precedes the reference configuration state of the respective change history record and which is most similar to the current configuration state assigned to the service request;
identifying for each change history record of the subset a reference set of installations and changes of configuration items, the reference set comprising the installations and changes of configuration items implemented according to the respective change history record in order to arrive at the reference configuration state starting from the starting configuration state of the respective change history record; and
the determined response comprising one or more installations and changes of configuration items comprised by a reference set selected from the reference sets of the change history records of the subset.

12. The computer implemented method of claim 11, said analyzing the service request comprising identifying service sub-requests comprised by the service request and the determined list of basic installations and changes of configuration items comprising basic installations and changes of configuration items required to be installed or changed in order to satisfy the service sub-requests.

13. The computer implemented method of claim 11, said subset of the set of change history records being extended by adding change history records with a reference configuration state which comprises a selected part of the target configuration state.

14. The computer implemented method of claim 11, said selected reference set being selected using satisfaction values assigned to the configuration states comprised by the change history records of the subset.

15. The computer implemented method of claim 14, said computer implemented method further comprising:
identifying, in real time by the one or more processors, a first change history record of the subset with the highest satisfaction value assigned to the reference configuration state of the respective change history record, the selected reference set being the reference set of the first change history record of the subset.

16. The computer implemented method of claim 14, the computer implemented method further comprising:
identifying, in real time by the one or more processors, an increase of the satisfaction values assigned a reference set of installations and changes of configuration items of a second change history record of the subset, said selected reference set being the reference set of the second change history record of the subset.

17. The computer implemented method of claim 16, said computer implemented method further comprising:
identifying, in real time by the one or more processors, installations and changes of configuration items of the reference set of the second change history record implemented previous to the increase of the satisfaction value;
checking, in real time by the one or more processors, whether the identified installations and changes of configuration items are comprised by reference sets of other change history records of the subset which do not comprise the same increase of satisfaction values,
in response to a determination that the identified installations and changes of configuration items are not comprised by reference sets of other change history records of the subset which do not comprise the same increase of satisfaction values, adding, in real time by the one or more processors, the identified installations and changes of configuration items to the response.

18. The computer implemented method of claim 1, said computer implemented method further comprising
transmitting, in real time by the one or more processors, the response to the service request to a sender of the service request.

19. A computer program product, comprising a computer-readable hardware storage device having machine executable program instructions embodied therein, said machine executable program instructions being configured to implement a computer implemented method for processing a service request of a service catalog, said computer implemented method comprising:
receiving, by one or more processors of a computer system, the service request;
determining, in real time by the one or more processors, context information comprising service context information of a service specification comprised by the service request;
calculating, in real time by the one or more processors, a predicted user satisfaction metric, using the service context information; and
based on a predicted user satisfaction indicated by the predicted user satisfaction metric, determining, in real time by the one or more processors, a response to the service request.

20. A computer system, comprising one or more processors, one or more memories, and one or more computer readable hardware storage devices, said one or more hardware storage device containing program code executable by the one or more processors via the one or more memories to implement a method for processing a service request of a service catalog, said method comprising:
receiving, by the one or more processors, the service request;
determining, in real time by the one or more processors, context information comprising service context information of a service specification comprised by the service request;
calculating, in real time by the one or more processors, a predicted user satisfaction metric, using the service context information; and
based on a predicted user satisfaction indicated by the predicted user satisfaction metric, determining, in real time by the one or more processors, a response to the service request.
